(19) United States
(12) Patent Application Publication
(10) Pub. No.: US 2013/0083625 A1
(43) Pub. Date: Apr. 4, 2013

(54) DEMODULATING A WAVEFIELD

(71) Applicant: Ralf Ferber, Horsham (GB)

(72) Inventor: Ralf Ferber, Horsham (GB)

(21) Appl. No.: 13/249,005

(22) Filed: Sep. 29, 2011

(51) Int. Cl. G01V 1/38; G10K 11/00

(52) U.S. Cl. 367/24; 367/141

(57) ABSTRACT

A technique includes demodulating a wavefield; generating spatial samples of the demodulated wavefield; and processing the samples to extract spectral components of the wavefield based at least in part on the demodulating.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both; other seismic sensors may be configured to include instrumentation that is sensitive to both pressure changes and particle motion, acceleration, and/or velocity. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In one implementation, a technique includes demodulating a wavefield; generating spatial samples of the demodulated wavefield; and processing the samples to extract spectral components of the wavefield based at least in part on the demodulating.

In another implementation, an apparatus includes sensors and a demodulator. The sensors acquire data indicative samples of a spatially varying wavefield. The demodulator selectively weights the samples to demodulate the wavefield.

In another implementation, an apparatus includes seismic sources and a controller. The controller controls the seismic sources to demodulate a composite wavefield produced by the sources. The demodulation adds information to a given wavenumber band of the composite wavefield to allow recovery of at least one spectral component associated with energy produced by at least one of the seismic sources.

In further implementations, the generating includes receiving spatial samples of the wavefield before demodulation, and the demodulating includes selectively weighting the received spatial samples to generate the spatial samples of the demodulated wavefield.

In further implementations, the generating includes receiving data indicative of the spatial samples from an array of sensors.

In further implementations, the demodulating includes selectively reversing polarities of electrical connections to sensors of a sensor array.

In further implementations, the selective reversal of the polarities includes selectively reversing the polarities based on a random or pseudorandom sequence.

In further implementations, the traces generated by the sensors are combined as a group and data indicative of the combined samples is communicated over a channel associated with the group.

In further implementations, the wavefield includes a composite seismic wavefield that is produced by a plurality of seismic sources, and the demodulating includes controlling the seismic sources to demodulate the composite seismic wavefield.

In further implementations, the control of the seismic sources includes selectively reversing polarities of sweeps generated by the seismic sources based on a random or pseudorandom sequence.

In further implementations, the seismic sources include vibroseis sources.

Advantages and other desired features will become apparent from the following drawings, description and claims.

### BRIEF DESCRIPTION OF THE DRAWINGS

FIG. 1 is a schematic diagram of a seismic acquisition system according to some embodiments.

FIG. 2 is an illustration of a system to demodulate and spatially sample a signal according to some embodiments.

FIG. 3 is a flow diagram depicting a technique to use wavefield demodulation to extend a wavenumber range of spectral content recovered from samples of a wavefield according to some embodiments.

FIG. 4 is a schematic diagram illustrating a receiver array system and a processing system to process data acquired by the receiver array system according to some embodiments.

FIG. 5 is a schematic diagram of a group of sensors illustrating wiring connections of the sensors according to some embodiments.

FIG. 6 is a flow diagram depicting a technique to selectively reverse polarities of electrical connections of sensors to perform demodulation of a wavefield sampled by the sensors according to some embodiments.

FIG. 7 is a schematic diagram of a source system according to some embodiments.

FIG. 8 is a flow diagram depicting a technique to demodulate a composite wavefield produced by seismic sources and process spatial samples of the composite wavefield according to some embodiments.

FIG. 9 is a schematic diagram of a processing system according to some embodiments.

### DETAILED DESCRIPTION

Seismic sensors may be deployed in a number of different platforms for purposes of acquiring measurements of seismic wavefields. For example, in a marine environment, a seismic survey system may include seismic sensors that are deployed on one or more seismic streamers that are towed by a surface vessel. Alternatively, a seismic survey system for the marine environment may include seismic sensors that are deployed on cables that are positioned on the seabed. Seismic sensors may also be deployed, for example, in wells, as part of a borehole seismic (BHS) survey system.

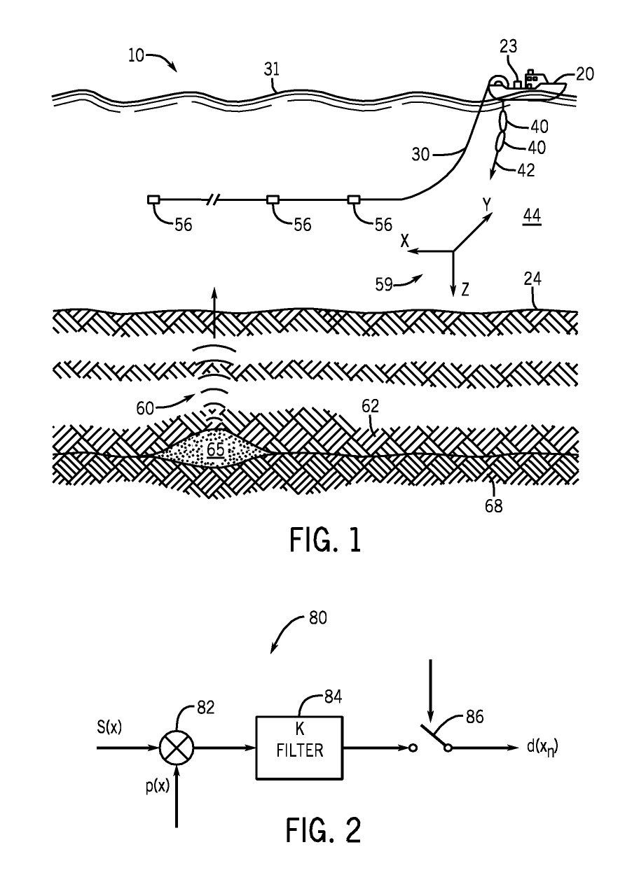

As a more specific non-limiting example, FIG. 1 depicts a marine-based, towed seismic data acquisition system 10, which includes a survey vessel 20 that tows one or more seismic streamers 30 (one streamer 30 being depicted in FIG. 1, as a non-limiting) behind the vessel 20. It is noted that the streamers 30 may be arranged in a spread in which multiple streamers 30 are towed in approximately the same plane at the same depth. As another non-limiting example, the streamers 30 may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. More specifically, the streamers 30 contain seismic sensors, which may be constructed to acquire pressure data and/or particle motion data.

As a more specific example, a given streamer 30 may contain multi-component sensor units 56 that contain pressure and particle motion sensors that are constructed to acquire measurements indicative of spatial samples of pressure and particle wavefields that are produced as part of a seismic survey. As a non-limiting example, each sensor unit 56 may contain a hydrophone to acquire spatial samples, or measurements, of a pressure wavefield and particle motion sensors to acquire spatial samples, or measurements, of components of a particle motion wavefield, such as, for example, cross-line (y) and vertical (z) components of the particle motion wavefield, where “y” and “z” refer to the orientation illustrated by axes 59.

For purposes of generating seismic wavefields, the acquisition system 10 includes seismic sources 40 (two seismic sources 40 being depicted as examples in FIG. 1), such as air guns and the like. In some embodiments, the seismic sources 40 may be coupled to, or towed by, the survey vessel 20. Alternatively, in other embodiments, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an acoustic signal 42 being depicted as an example in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as, for example, a geological formation 65 that is depicted in FIG. 1.

The incident acoustic signals 42 that are created by the sources 40 produce corresponding reflected acoustic signals, or pressure waves 60, which create the pressure and particle motion wavefields that are sensed by the sensors of the seismic units 56 (i.e., the sensors spatially sample the particle motion and pressure wavefields). It is noted that the seismic waves that are received and sensed by the seismic sensors include “up going” seismic waves that propagate to the sensors after reflections at the subsurface, as well as “down going” seismic waves that are produced by reflections of the pressure waves 60 from an air-water boundary, or free surface 31.

The seismic sensors generate signals (digital signals, for example), called “traces,” which indicate the acquired measurements of the pressure and particle motion. The traces may be recorded and at least partially processed by a signal processing unit 23 that is deployed on the survey vessel 20, in accordance with some embodiments. For example, a particular seismic sensor may provide a trace, which corresponds to a pressure measurement by its hydrophone; and the sensor may provide (depending on the particular embodiment) one or more measurements of one or more traces that correspond to one or more components of particle motion.

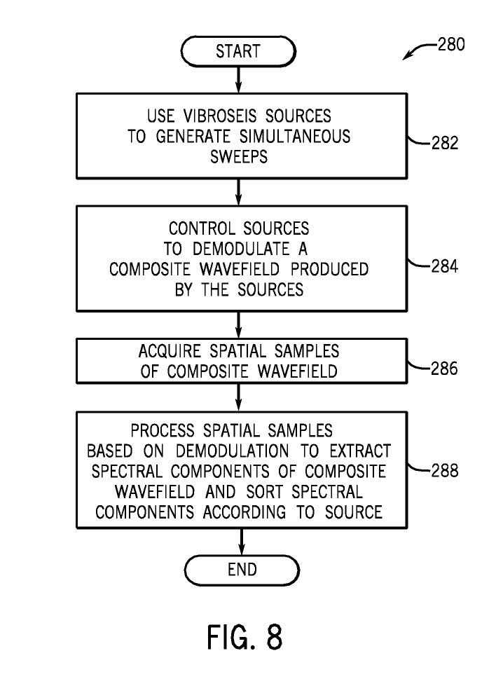

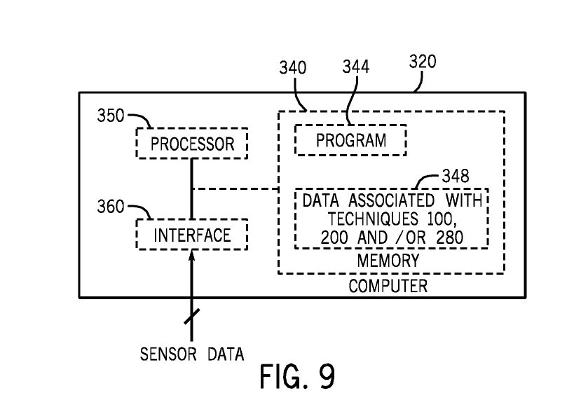

The goal of the seismic acquisition is to build up an image of a survey area for purposes of identifying subterranean geological formations, such as, for example, the geological formation 65. Subsequent analysis of the representation may reveal probable locations of hydrocarbon deposits in subterranean geological formations. Depending on the particular embodiment, portions of the analysis of the representation may be performed by a data processing system on the seismic survey vessel 20, such as by the signal processing unit 23. In accordance with other embodiments, the analysis may be performed/further performed by a seismic data processing system that may be, for example, located on land. Thus, many variations are possible and are within the scope of the appended claims. An example data processing system 320 is depicted in more detail in FIG. 8 and described below.

The seismic sensors acquire spatial samples of the sensed wavefields, and the corresponding spatial sampling rate is established by the spacing of the sensors (i.e., the distances between the sensors). For example, the inline (x) and crossline (y) spacings of the hydrophones establish the corresponding spatial sampling rates of the pressure wavefield in the inline and crossline directions, respectively. In general, a given sensor spacing is associated with a Nyquist wavenumber. In this manner, in accordance with the Nyquist sampling theorem (also referred to as the Shannon sampling theorem), the Nyquist wavenumber is a function of the sensor spacing and is the maximum wavenumber of this signal for which spectral content may be fully recovered (i.e., recovered without being corrupted due to aliasing) from samples of the signal. Decreasing the sensor spacing (i.e., increasing the spatial sampling rate) allows the recovery of unaliased spectral content for higher wavenumbers, and vice versa.

FIG. 2 depicts a system 80 that permits the full recovery of spectral content for certain sampled signals for wavenumbers above the Nyquist wavenumber, i.e., the system 80 relaxes the Nyquist sampling requirement. More specifically, FIG. 2 illustrates a spatially varying signal (called “S(x)” in FIG. 2), which may be, as examples, a pressure wavefield or a particle motion wavefield. A switch 86 depicts the spatial sampling of the S(x) signal to produce samples, which are represented by a discrete signal, called “d(xₙ)” in FIG. 2, where “xₙ” represents the nth sample.

According to the Nyquist sampling theorem, if the S(x) signal is band-limited by a wavenumber filter 84 to a maximum wavenumber called “k_{MAX}” (the Nyquist wavenumber for this example), then a sampling distance of

$$\frac{1}{2 \cdot {k}_{MAX}}$$

or less between the sensors is sufficient to fully recover the S(x) signal from the d(xₙ) discrete signal. Otherwise, according to the Nyquist sampling theorem, the bandlimited S(x) signal is not fully recoverable from the samples. The system 80, however, relaxes the Nyquist sampling requirement by including a demodulator 82, which demodulates the S(x) signal to add additional information to the d(xₙ) discrete signal to permit spectral components of the S(x) signal associated with wavenumbers greater than the k_{MAX} wavenumber to be recovered from the d(xₙ) discrete signal.

In some embodiments, the ability of the system 80 to relax the Nyquist sampling requirement is due in part to the S(x) signal being spectrally sparse, in that the spectrum of the S(x) signal does not use the full wavenumber band that is imposed by the filter 84, but rather, the spectrum resides in a small portion of the band. The demodulator 82, which may be viewed as being a multiplier, demodulates the S(x) signal by multiplying the S(x) signal with a signal called “p₍ₓ₎,” which varies with respect to space in a random or pseudorandom manner. The demodulation of the S(x) signal using the random or pseudorandom p₍ₓ₎ signal smears, or spreads, the individual spectral lines of the S(x) signal across the wavenumber spectrum. Due to the spectral components of the S(x) signal being spectrally sparse, the demodulation produces a spectrum in which each spectral line (associated with a particular sparse wavenumber) in the demodulated signal has a distinct signature within the passband of the filter 84. Because relatively few spectral lines are present in the resulting d(xₙ) discrete signal, the spectral lines and their amplitudes may be readily identified from the d(xₙ) discrete signal, even if the spatial sampling rate is associated with a Nyquist wavenumber that is less than the k_{MAX} wavenumber that is imposed by the filter 84.

The system 80 of FIG. 2 may be used for purposes of demodulating a seismic wavefield, such as a pressure wavefield or a particle motion wavefield. In this manner, for this application of the system 80, the S(x) signal represents the wavefield, and the d(xₙ) discrete signal represents the sampled wavefield, i.e., the output stream produced by the sensors. In general, the d(xₙ) discrete signal is bandlimited, due to the finite wavenumber responses of the sensors, thereby imposing passband restrictions. Moreover, in accordance with some embodiments disclosed herein, the modulation of the wavefield may be achieved by selectively weighting the d(xₙ) discrete signal (here, the sensor-provided measurements) according to a pseudorandom or random sequence. In other words, some sensor outputs are weighted and the other sensor outputs are not weighted, according to which sensors are identified for weighting by the pseudorandom/random sequence. Using knowledge regarding which of the samples of the d(xₙ) discrete signal are weighted, in turn, the d(xₙ) discrete signal may be processed to recover spectral components of the sampled wavefield while suppressing aliasing effects, which may otherwise be present without the demodulation.

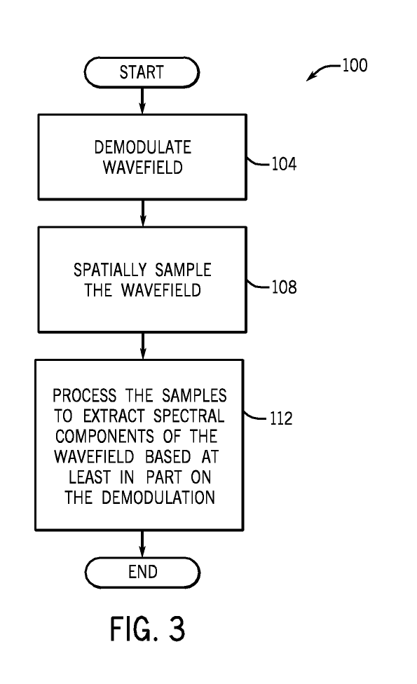

More specifically, referring to FIG. 3, in accordance with some embodiments, a technique 100 includes demodulating (block 104) a wavefield and spatially sampling (block 108) the wavefield. As noted above, the demodulation may occur, in accordance with some embodiments disclosed herein, by selectively applying weights to the samples of the wavefield according to a pseudorandom or random sequence. Pursuant to the technique 100, the samples are processed (block 112) to extract spectral components of the wavefield based at least in part on the demodulation (for example, based on knowledge regarding the weights and which samples were weighted).

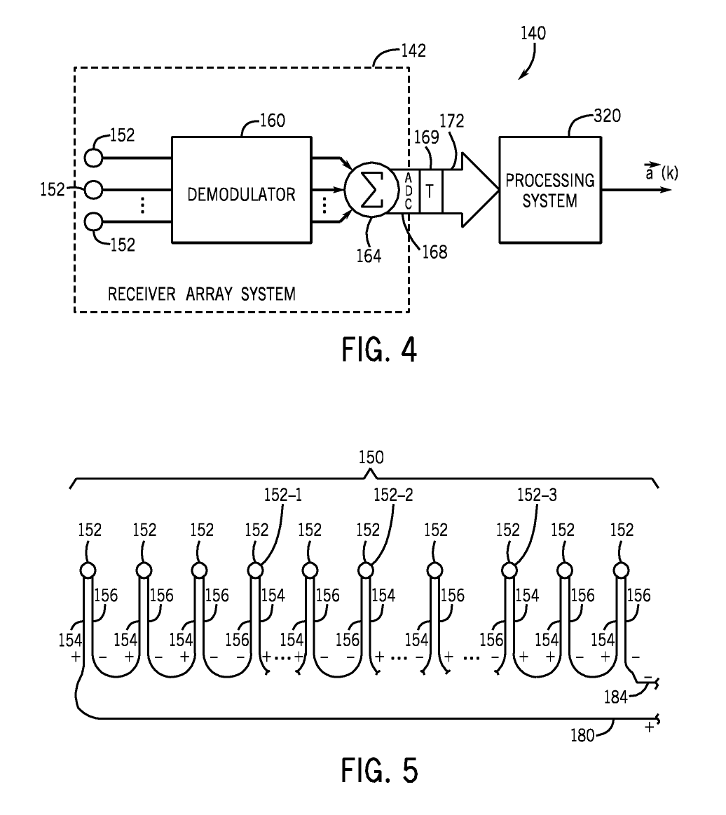

FIG. 4 depicts a system 140 to sample a seismic wavefield and process the sampled wavefield to determine spectral components (called “\vec{a}(k)” in FIG. 4) of the wavefield. More specifically, the system 140 includes a receiver array system 142, which includes seismic sensors 152 that are coupled to a demodulator 160. The demodulator 160 selectively applies weights to the measurements acquired by the sensors 152 according to a random or pseudorandom sequence. The resulting weighted seismic data is communicated to a processing system 320, which extracts the \vec{a}(k) spectral components of the sampled wavefield using techniques that are disclosed herein.

The systems and techniques that are disclosed herein may be particularly useful for purposes of analog group forming in which the data from several seismic sensors are combined before being transmitted over a particular channel of the survey system. In this regard, seismic sensors may be relatively inexpensive, as compared to the recording channels that are used to communicate the sensor data.

More specifically, in accordance with some embodiments, the sensors 152 of FIG. 4 represent a group of sensors that are wired together in a manner to form an analog group. Thus, the other sensors of the sensor platform may likewise be wired to form corresponding analog groups, which may be referred to as “analog group forming.” An example analog group 150 of the sensors 152 is depicted in FIG. 5. Still referring to FIG. 4, the sensors 152 form a composite analog signal, which may then be digitized (via an analog-to-digital converter (ADC)) and communicated across a single channel to a recording subsystem. The formation of the analog group is schematically depicted in FIG. 4 by an adder 156 combining (i.e., adding) the weighted samples provided by the demodulator 160 together for purposes of producing an analog signal that is indicative of the combined sensor measurements. This signal, in turn, is digitized by an ADC 168 and transmitted via a transmitter 169 to the processing system 320 via a channel 172.

Referring to FIG. 5 depicts an analog group 150 of sensors 152 according to a non-limiting example, the sensors 152 are wired together to produce a composite analog sensor signal for the analog group 150, which appears on terminals 184 (the positive terminal) and 180 (the negative terminal) for the group 150. In general, sensor terminals of each sensor 152 are wired together to positively add the output signals from the sensors 152 together. In this manner, each sensor 150 includes a positive terminal 154 and a negative terminal 156. Except for the positive terminal 154 of the sensor 152 that is coupled to the positive terminal 184 and the negative terminal 156 of the sensor 152 that is coupled to the negative terminal 180, in general, the negative terminal 156 of a given sensor 152 is coupled to the positive terminal 154 of the adjacent sensor 152. In general, the sensor 152 may be viewed as having a certain polarity orientation defined by the orientation in which the sensor 152 is “plugged” into a connector on the streamer 30.

As illustrated in FIG. 5, however, the polarities of the sensors 152 may be varied for the group 150 in a random or pseudorandom manner according to a random or pseudorandom sequence for purposes of demodulating the wavefield that is sampled by the sensors 152. In other words, for this example, the demodulator 160 and adder 164 of FIG. 4 are formed by the wiring connections of the sensors 152. More specifically, for the example that is depicted in FIG. 5, the sensors 152-1, 152-2 and 152-3 have been selected according to the random or pseudorandom sequence, the polarities of these sensors are reversed. For example, the positive 154 and negative 156 terminals of the sensor 152-1 are coupled to the positive 154 and negative 156 terminals, respectively, of the sensors 152 adjacent to the sensor 152-1. Thus, for the arrangement depicted in FIG. 5, a weight of “−1” is applied to the output of each of the sensors 152-1, 152-2 and 152-3, whereas a weight of the “1” is applied to the outputs of the other sensors 152.

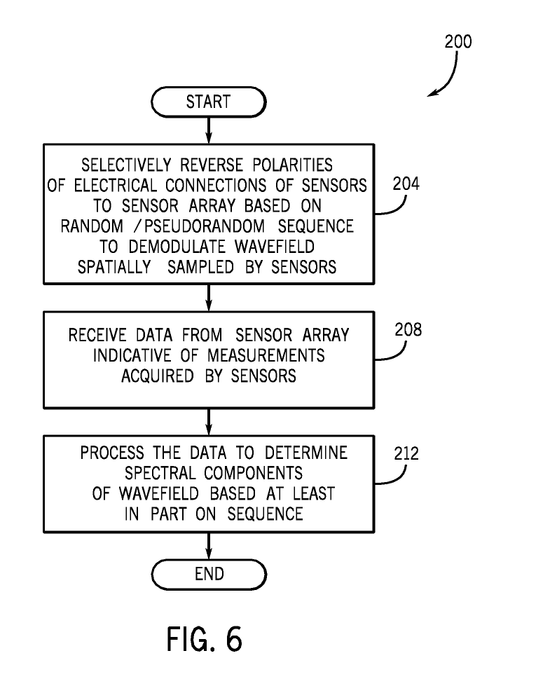

Referring to FIG. 6, to summarize, a technique 200 may be used in accordance with some embodiments. Pursuant to the technique 200, polarities of sensor connections to a sensor array are selectively reversed (block 204) based on a random/pseudorandom sequence to demodulate a wavefield that is spatially sampled by the sensors. The data from the sensor array may then be received (block 208), which is indicative of measurements that are acquired by the sensors. The data is processed (block 212) to determine spectral components of the wavefield based at least in part on the random/pseudorandom sequence.

It is noted that the above-described selective polarity reversal is an example of one out of many possible implementations of the demodulator 160 (FIG. 4) and adder 164 (FIG. 4). In other implementations, the demodulator 160 and/or adder 154 may be formed from, as examples, analog (analog multipliers and adders, for example) or digital (logic and/or processor-based circuitry, for example) to selectively weight and add the samples together. In yet other implementations, group forming may not be employed. Thus, many variations are contemplated, which are within the scope of the appended claims.

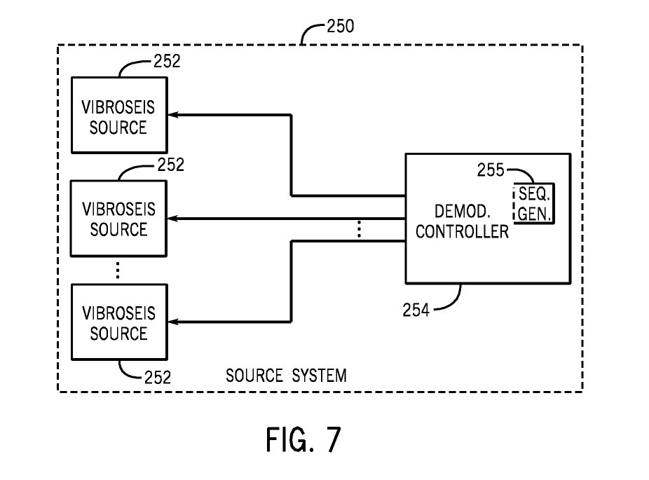

The techniques and systems that are disclosed herein may also be used for source systems, such as a source system 250 that is depicted for purposes of example in FIG. 7. In this regard, in accordance with some embodiments, a demodulation controller 254 controls vibroseis sources 252, which simultaneously generate vibroseis signals that are sensed by corresponding seismic sensors (not shown). In general, the demodulation controller 254 may contain a pseudorandom or random generator 255, which causes the controller 254 to change weights of source patterns that are generated by the sources 252 by selecting the sources 252 to which the weight are applied according to a pseudorandom or random sequence.

For example, in accordance with some embodiments, the controller 254 uses the pseudorandom/random sequence to select vibroseis sources 252 and more particularly, select sweeps of the sources 252 whose polarities are reversed when selected. Due to the random or pseudorandom demodulation of the vibroseis sources 252 using the polarity changes, the resulting composite wavefield that is produced by the sources 252 contains extra information, which allows the sensed energy produced by the sources 252 to be sorted according to the source 252 that produced the energy. Thus, in accordance with some embodiments, the demodulation techniques disclosed herein may be used for purposes of source separation. In other embodiments, additional information, whether information imparted by phase rotation, source dithering, etc., may be used for purposes of enhancing the source separation. Thus, many variations are contemplated, which are within the scope of the appended claims.

Referring to FIG. 8, a technique 280, in accordance with some embodiments, includes using (block 282) vibroseis sources to generate simultaneous sweeps and controlling (block 284) the sources to demodulate a composite wavefield by the sources. Spatial samples may then be acquired (block 286) of the composite wavefield and processed (block 288) based on the demodulation to extract spectral components of the composite wavefield and sort these components according to the originating source.

Knowledge of the manner in which the wavefield is demodulated may be used to recover the spectral components of the sampled wavefield. As a more specific example, the spatially sampled data (called “\vec{d}” below) may be represented in terms of its inverse Fourier transform (called “F”) and wavenumber spectrum samples, or spectral components, (called “\vec{a}”), as follows:

\vec{d}=F\vec{a}, Eq. 1

where “\vec{d}” may be described as follows:

\vec{d}=(d(x₁), . . . , d(x_{N})), and Eq. 2

“\vec{a}” may described as follows:

\vec{a}=(a(k₁), . . . , a(k_{M})). Eq. 3

Assuming for this example that the demodulation involves the use of selective polarity reversals, the demodulation involves multiplying both sides of Eq. 1 by a diagonal matrix with random plus or minus one values along its diagonal. This matrix (called “D” herein) may be described as follows:

$$D = ( \begin{matrix}{e}_{1} & 0 & 0 & 0 \\ 0 & {e}_{2} & 0 & 0 \\ 0 & 0 & ⋯ & 0 \\ 0 & 0 & 0 & {e}_{N}\end{matrix} ) .$$

Assuming for this example that analog group forming is employed, analog group forming after demodulation may be described by multiplying both sides of Eq. 1 with another diagonally dominant matrix with values of one staggered along the diagonal. Instead of a row of “ones” the samples of any low-pass filter could be placed on the diagonal as well. This matrix (called “G” herein) may be described as follows:

$$G = ( \begin{matrix}11 …1 & 0 & 0 & 0 \\ 0 & 11 …1 & 0 & 0 \\ 0 & 0 & 11 …1 & 0 \\ 0 & 0 & 0 & 11 …1\end{matrix} ) .$$

Thus, the resulting data vector (called “\vec{d}_{RD}” herein) after analog group-forming and random demodulation may be described as follows:

\vec{d}_{RD}=GD\vec{d}=GDF\vec{a}. Eq. 4

Equation 4 may be solved for the \vec{a} spectral components using as a non-limited example, an L1-norm solver, such as the L1-Dantzig selector algorithm.

Referring to FIG. 9, in accordance with some embodiments, a data processing system 320, or computer, may contain a processor 350 for purposes of processing sensor data indicative of demodulated wavefield samples for purposes of performing at least one or more the techniques that are disclosed herein to extract the spectral components of the sampled wavefields from the data.

In accordance with some embodiments, the processor 350 may be formed from one or more microprocessors and/or microprocessor processing cores. As non-limiting examples, the processor 350 may be located on the vessel (see FIG. 1), located at a land-based processing facility, disposed at a well site in which a sensor cable is deployed in a well, etc., depending on the particular embodiment. Moreover, the data processing system 320 may be a distributed processing system, distributed across local or remote processing nodes, in accordance with some embodiments.

As depicted in FIG. 8, the processor 350 may be coupled to a communication interface 360 for purposes of receiving the sensor data. As examples, the communication interface 360 may be a Universal Serial Bus (USB) interface, a network interface, a removable media interface (a flash card, CD-ROM interface, etc.) or a magnetic storage interface (IDE or SCSI interfaces, as non-limiting examples). Thus, the communication interface 360 may take on numerous forms, depending on the particular embodiment.

In accordance with some embodiments, the processor 350 is coupled to a memory 340, which stores program instructions 344, which when executed by the processor 350, may cause the processor 350 to perform various tasks of one or more of the techniques that are disclosed herein, such as the techniques 100, 200 and/or 280, as non-limiting examples. It is noted that the memory 340 is a non-transitory memory and may take on numerous forms, such as semiconductor storage, magnetic storage, optical storage, phase change memory storage, capacitor-based storage, etc., depending on the particular implementation. Furthermore, the memory 340 may be formed from more than one of these non-transitory memories, in accordance with some embodiments. When executing the program instructions 344, the processor 340 may also, for example, store preliminary, intermediate and/or final results obtained via the execution of the program instructions 344 as data 348 in the memory 340.

It is noted that the data processing system 320 is merely an example of one out of many possible architectures for processing the sensor data in accordance with the techniques that are disclosed herein. Moreover, the data processing system 320 is represented in a simplified form, as the processing system 320 may have various other components (a display to display initial, intermediate or final results of the system's processing, as a non-limiting example), as can be appreciated by the skilled artisan. Thus, many variations are contemplated, which are within the scope of the appended claims.

In accordance with some embodiments, the demodulator 154 (see FIG. 4) and/or the controller 254 (see FIG. 7) may have an architecture similar to the processing system 320 for purposes of performing the pseudorandom or random demodulation, as described herein.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
demodulating a wavefield;
generating spatial samples of the demodulated wavefield; and
processing the samples to extract spectral components of the wavefield based at least in part on the demodulating.

2. The method of claim 1, wherein the generating comprises receiving spatial samples of the wavefield before demodulation and the demodulating comprises selectively weighting the received spatial samples to generate the spatial samples of the demodulated wavefield.

3. The method of claim 1, wherein the generating comprises receiving data indicative of the spatial samples from an array of sensors.

4. The method of claim 1, wherein the demodulating comprises selectively reversing polarities of electrical connections to sensors of a sensor array.

5. The method of claim 4, wherein the act of selectively reversing the polarities comprises selectively reversing the polarities based on a random or pseudorandom sequence.

6. The method of claim 1, further comprising combining traces generated by the sensors as a group and communicating data indicative of the combined samples over a channel associated with the group.

7. The method of claim 1, wherein the wavefield comprises a composite seismic wavefield produced by a plurality of seismic sources and the demodulating comprises controlling the seismic sources to demodulate the composite seismic wavefield.

8. The method of claim 7, wherein the act of controlling the seismic sources comprises selectively reversing polarities of sweeps generated by the seismic sources based on a random or pseudorandom sequence.

9. An apparatus comprising:
sensors to acquire data indicative samples of a spatially varying wavefield; and
a demodulator to selectively weight the samples to demodulate the wavefield.

10. The apparatus of claim 9, wherein the sensors are part of a sensor array and the demodulator comprises electrical connections of the sensors to the array, the polarities of the electrical connections being changed according to a pseudorandom sequence.

11. The apparatus of claim 9, further comprising an aggregator to combine data provided by two or more of the sensors to form data associated with a sensor group and communicated over an associated channel.

12. The apparatus of claim 9, further comprising a processing system to receive data indicative of the weighted samples and extract spectral components of the wavefield based at least in part on data identifying which samples were weighted.

13. The apparatus of claim 9, wherein the sensors comprise seismic sensors disposed on a seismic receiver platform selected from a group consisting of a seismic streamer platform and a borehole platform.

14. The apparatus of claim 9, further comprising:
a vessel to tow the sensors and the demodulator.

15. The apparatus of claim 9, wherein the sensors comprise sensors selected from the group consisting of pressure sensors and particle motion sensors.

16. An apparatus comprising:
seismic sources; and
a controller to control the seismic sources to demodulate a composite wavefield produced by the sources, the demodulation adding information to a given wavenumber band of the composite wavefield to allow recovery of at least one spectral component associated with energy produced by at least one of the seismic sources.

17. The apparatus of claim 16, wherein the controller is adapted to selectively reverse polarities of the sources.

18. The apparatus of claim 16, wherein the seismic sources comprise vibroseis sources and the controller is adapted to selectively reverse polarities of sweeps generated by the sources.

19. The apparatus of claim 16, wherein the controller comprises a pseudorandom generator and the controller is adapted to control the seismic sources based on an output of the generator.

20. The apparatus of claim 16, wherein the seismic sources comprise vibroseis sources.
